(19) United States
(12) Patent Application Publication
(10) Pub. No.: US 2023/0082753 A1
(43) Pub. Date: Mar. 16, 2023

(54) STRUCTURE INSPECTION METHOD AND STRUCTURE INSPECTION SYSTEM

(71) Applicant: FUJIFILM Corporation, Tokyo (JP)

(72) Inventors: Tadashi KASAMATSU, Ashigarakami-gun (JP); Makoto YONAHA, Tokyo (JP); Naoko YOSHIDA, Ashigarakami-gun (JP)

(73) Assignee: FUJIFILM Corporation, Tokyo (JP)

(21) Appl. No.: 18/050,848

(22) Filed: Oct. 28, 2022

Related U.S. Application Data
(63) Continuation of application No. PCT/JP2021/019702, filed on May 25, 2021.

(30) Foreign Application Priority Data
May 29, 2020 (JP) 2020-094327

(51) Int. Cl. G01N 21/88; G01N 29/06; G01N 22/02; G06T 7/00

(52) U.S. Cl. CPC G01N 21/8851; G01N 29/069; G01N 22/02; G06T 7/0004; G01N 2291/0289; G06T 2207/20016; G06T 2207/30108

(57) ABSTRACT

Provided are a structure inspection method and a structure inspection system capable of efficiently inspecting structure and predicting deterioration with high accuracy. The structure inspection method includes: acquiring information on a location having internal damage within an inspection target region; and imaging the inspection target region with a visible light camera a plurality of times while shifting an imaging location, wherein a location except for the location having the internal damage is imaged with first pixel resolution and the location having internal damage is imaged with second pixel resolution higher than the first pixel resolution. Damage appearing on a surface of the structure is detected on the basis of a visible light image captured by the visible light camera. Information on the location having internal damage within the inspection target region is acquired by capturing an image that visualizes an internal state of the inspection target region.

### CROSS-REFERENCE TO RELATED APPLICATIONS

The present application is a Continuation of PCT International Application No. PCT/JP2021/019702 filed on May 25, 2021 claiming priority under 35 U.S.C § 119(a) to Japanese Patent Application No. 2020-094327 filed on May 29, 2020. Each of the above applications is hereby expressly incorporated by reference, in its entirety, into the present application.

### BACKGROUND OF THE INVENTION

### 1. Field of the Invention

The present invention relates to a structure inspection method and a structure inspection system.

### 2. Description of the Related Art

As methods of non-destructively inspecting (checking) an inside of a structure made of reinforced concrete, such as a bridge and a tunnel, an infrared photographic method (for example, JP2005-37366A), an electromagnetic wave radar method (for example, JP2020-051851A), an ultrasonic method (for example, JP2019-070627A), an X-ray angiographic method (for example, JP2000-193611A), and the like are known.

### SUMMARY OF THE INVENTION

Meanwhile, in the inspection of a structure, it is necessary to predict deterioration on the basis of an inspection result to perform repair, reinforcement, and the like, as necessary. However, it is not possible to predict deterioration with high accuracy only on the basis of the inspection result of the inside of the structure. Damage appearing on a surface of the structure is also inspected, whereby it is possible to predict deterioration with high accuracy. However, a detailed inspection of all surfaces of the structure has a drawback of requiring a great deal of time.

The present invention has been made in view of such circumstances, and an object of the present invention is to provide a structure inspection method and a structure inspection system capable of efficiently inspecting a structure and predicting deterioration with high accuracy.

(1) A structure inspection method comprising: a step of acquiring information on a location having internal damage within an inspection target region; and a step of imaging the inspection target region with a visible light camera a plurality of times while shifting an imaging location, in which a location except for the location having the internal damage is imaged with a first pixel resolution and the location having the internal damage is imaged with a second pixel resolution higher than the first pixel resolution.

(2) The structure inspection method of (1), further comprising: a step of non-destructively measuring an internal state of the inspection target region.

(3) The structure inspection method of (2), in which the internal state of the inspection target region is non-destructively measured by capturing an image that visualizes the internal state of the inspection target region.

(4) The structure inspection method of (3), in which the image that visualizes the internal state of the inspection target region is captured using an electromagnetic wave or an ultrasonic wave.

(5) The structure inspection method of (4), in which the image that visualizes the internal state of the inspection target region is captured using a millimeter wave, a microwave, or a terahertz wave.

(6) The structure inspection method of any one of (3) to (5), in which the inspection target region is imaged a plurality of times while shifting the imaging location in a case where the image that visualizes the internal state of the inspection target region is captured.

(7) The structure inspection method of (2), in which the internal state of the inspection target region is measured by a non-contact acoustic exploration method.

(8) The structure inspection method of any one of (1) to (7), further comprising: a step of detecting damage appearing on a surface of the structure on the basis of a visible light image captured by the visible light camera.

(9) The structure inspection method of any one of (1) to (8), in which a location where delamination has occurred is detected as the location having the internal damage to the structure.

(10) The structure inspection method of any one of (1) to (9), in which the first pixel resolution is a pixel resolution capable of detecting fissuring with a width of up to 0.2 mm from a visible light image captured by the visible light camera, and the second pixel resolution is a pixel resolution capable of detecting fissuring with at least a width of up to 0.1 mm from the visible light image captured by the visible light camera.

(11) A structure inspection method comprising: a step of imaging an inspection target region of a structure with a visible light camera; a step of detecting damage appearing on a surface of the structure on the basis of a visible light image captured by the visible light camera; and a step of non-destructively measuring an internal state of a location where specific damage is detected, in a case where the specific damage is detected.

(12) The structure inspection method of (11), in which in the step of imaging the inspection target region with the visible light camera, imaging is performed with a pixel resolution capable of detecting fissuring with at least a width of up to 0.1 mm from the captured visible light image, and in the step of non-destructively measuring the internal state of the location where the specific damage is detected, an internal state of a location where fissuring with a width of less than 0.2 mm is detected is non-destructively measured.

(13) The structure inspection method of (11) or (12), in which the internal state of the location where the specific damage is detected is non-destructively measured by capturing an image that visualizes the internal state of the location where the specific damage is detected.

(14) The structure inspection method of (13), in which the image that visualizes the internal state of the location where the specific damage is detected is captured using an electromagnetic wave or an ultrasonic wave.

(15) The structure inspection method of (14), in which the image that visualizes the internal state of the location where the specific damage is detected is captured using a millimeter wave, a microwave, or a terahertz wave.

(16) The structure inspection method of (11) or (12), in which the internal state of the location where the specific damage is detected is measured by a non-contact acoustic exploration method.

(17) The structure inspection method of any one of (11) to (16), in which in the step of imaging the inspection target region with the visible light camera, the inspection target region is imaged with the visible light camera a plurality of times while shifting an imaging location.

(18) A structure inspection system comprising: a first camera that captures an image which visualizes an internal state of a structure; a second camera that captures a visible light image of a surface of the structure; and a detection device that acquires the visible light image captured by the second camera and detects damage appearing on the surface of the structure, in which in a case where the visible light image of a surface of an inspection target region of the structure is captured by the second camera, information on a location having internal damage is acquired by capturing an image that visualizes an internal state of the inspection target region of the structure with the first camera in advance, and a location except for the location having the internal damage is imaged with a first pixel resolution, and the location having the internal damage is imaged with a second pixel resolution higher than the first pixel resolution.

According to the present invention, it is possible to efficiently inspect a structure and predict deterioration with high accuracy.

### BRIEF DESCRIPTION OF THE DRAWINGS

FIG. 1 is a schematic configuration diagram of a system used for an inspection.

FIG. 2 is a block diagram showing an example of a hardware configuration of a damage diagram creation support device.

FIG. 3 is a block diagram of a main function of the damage diagram creation support device.

FIG. 4 is a diagram showing an example of a damage diagram in which delamination is recorded.

FIG. 5 is a diagram showing an example of a damage diagram in which fissuring is recorded.

FIG. 6 is a diagram showing an example of a damage diagram in which both delamination and fissuring are recorded.

FIG. 7 is a plan view showing a schematic configuration of a floor slab.

FIG. 8 is a flowchart showing an inspection procedure through a structure inspection method of a first embodiment.

FIG. 9 is a diagram showing an example of capturing a millimeter wave image in one coffer.

FIG. 10 is a diagram showing an example of capturing a visible light image in one coffer.

FIG. 11 is a flowchart showing an imaging procedure performed by a visible light camera.

FIG. 12 is a conceptual diagram of visible light image capturing processing in a region where no delamination is detected.

FIG. 13 is a conceptual diagram of visible light image capturing processing in a region where delamination is detected.

FIG. 14 is a flowchart showing an inspection procedure through a structure inspection method of a second embodiment.

FIG. 15 is a diagram showing an example of a fissuring damage diagram generated by inspection using a visible light image.

### DESCRIPTION OF THE PREFERRED EMBODIMENTS

Hereinafter, preferred embodiments of the present invention will be described with reference to the accompanying drawings.

### First Embodiment

Here, a case of inspecting (checking) a structure made of reinforced concrete, such as a bridge, a tunnel, and a building, will be described as an example.

[System Used for Inspection]

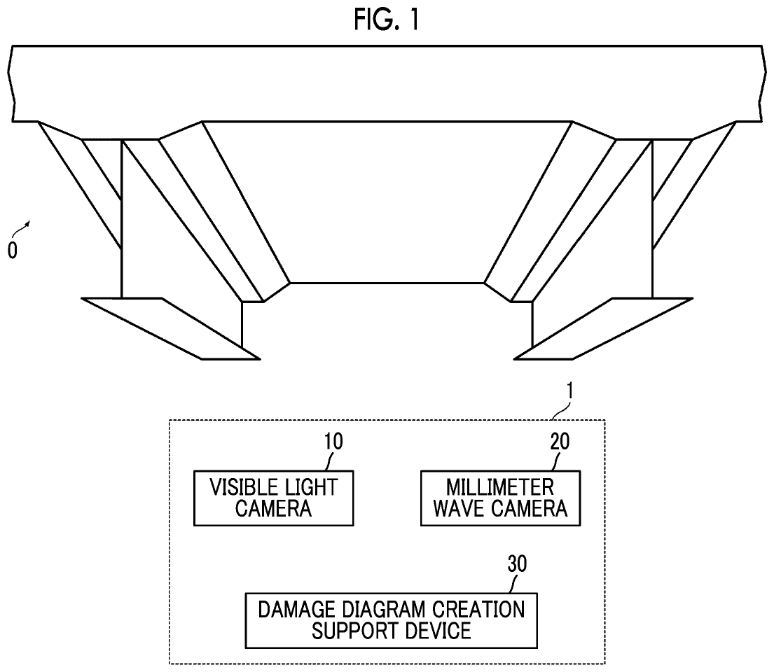

FIG. 1 is a schematic configuration diagram of a system used for an inspection.

As shown in FIG. 1, a system 1 used for an inspection of the present embodiment comprises a visible light camera 10 that images the outer surface of a structure O, a millimeter wave camera 20 that captures a millimeter wave image which visualizes the internal state of the structure O, and a damage diagram creation support device 30 that supports the creation of a damage diagram.

[Visible Light Camera]

The visible light camera 10 is a camera that images a subject with sensitivity in a visible light wavelength range (generally from 380 nm to 780 nm). As the visible light camera 10, a general digital camera (including a camera mounted on a mobile terminal or the like) on which a complementary metal-oxide semiconductor device image sensor (CMOS image sensor), a charge coupled device image sensor (CCD image sensor) or the like is mounted can be used. In the present embodiment, a digital camera capable of color imaging is used. Therefore, a color image is captured as a visible light image. The color image is an image (a so-called RGB image) having respective intensity values (brightness values) of red (R), green (G), and blue (B) in a pixel unit.

A user (inspector) images the outer surface of an inspection target region of the structure O with the visible light camera 10. The captured image (visible light image) is used to detect damage (fissuring, scaling, reinforcing bar exposure, water leakage (including rust juice), free lime, discoloration of concrete, and the like) appearing on the outer surface of the structure O. In particular, the captured image is used to detect fissuring in the present embodiment. The visible light camera 10 is an example of the second camera.

[Millimeter Wave Camera]

A so-called active millimeter wave camera (millimeter wave imaging device) is used in the inspection of the present embodiment. The millimeter wave camera is an example of the first camera. The active millimeter wave camera irradiates the subject with a millimeter wave, receives the reflected wave, and generates an image (millimeter wave image) that visualizes the internal state of the subject. The millimeter wave is an electromagnetic wave with a wavelength of 1 to 10 mm and a frequency of 30 to 300 GHz. The millimeter wave camera 20, for example, electronically or mechanically scans the subject with a millimeter wave beam to generate a two-dimensional image of the internal state of the subject within the angle of view. A plurality of transmitting antennas and a plurality of receiving antennas are used so that imaging can be speeded up. For example, the two-dimensional image can be generated by arranging the plurality of receiving antennas in one direction and scanning the subject in a direction orthogonal to the arrangement direction. In a case where the plurality of transmitting antennas and the plurality of receiving antennas are used, resolution can be improved by adopting a so-called multiple input multiple output (MIMO) radar technology. MIMO is a technology that generates more virtual receiving antennas than the number of installed receiving antennas by transmitting signals from the plurality of antennas.

The millimeter wave camera 20 has a display as a display unit, and a captured millimeter wave image is displayed on the display. The user looks at the millimeter wave image displayed on the display to confirm the internal condition of the inspection target region. In the present embodiment, the delamination of concrete is detected. The delamination of concrete refers to a state in which the vicinity of the surface of concrete is delaminated. The delamination of concrete means a state in which the concrete in the vicinity of the surface loses its integrity with the internal concrete due to continuous fissuring occurring inside the concrete or the like.

[Damage Diagram Creation Support Device]

The damage diagram creation support device 30 includes, for example, a general-purpose computer, such as a personal computer.

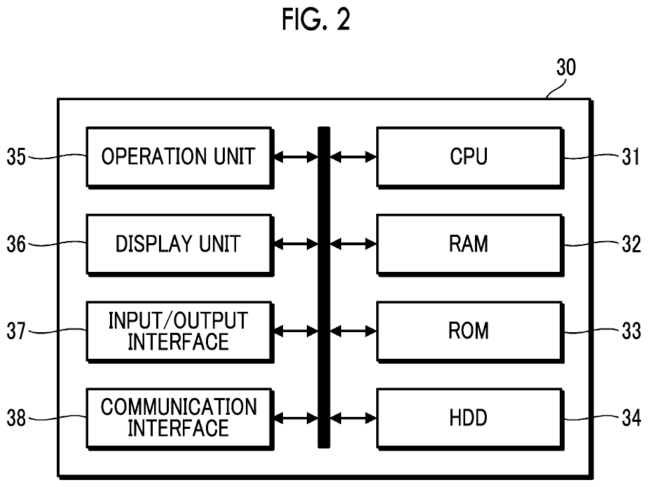

FIG. 2 is a block diagram showing an example of the hardware configuration of the damage diagram creation support device.

The damage diagram creation support device 30 comprises a central processing unit (CPU) 31, a random access memory (RAM) 32, a read only memory (ROM) 33, a hard disk drive (HDD) 34, an operation unit 35, a display unit 36, an input/output interface (IF) 37, a communication interface 38, and the like. Various kinds of data and a program executed by the CPU 31 are stored in the ROM 33 and/or the HDD 34. The operation unit 35 includes, for example, a keyboard, a mouse, and a touch panel. The display unit 36 includes, for example, a liquid crystal display (LCD) and an organic EL display (organic light emitting diode display, OLED display). The input/output interface 37 includes, for example, a universal serial bus (USB). The damage diagram creation support device 30 is communicably connected to an external device via the input/output interface 37. In addition, the damage diagram creation support device 30 is connected to a network (for example, the Internet) via the communication interface 38.

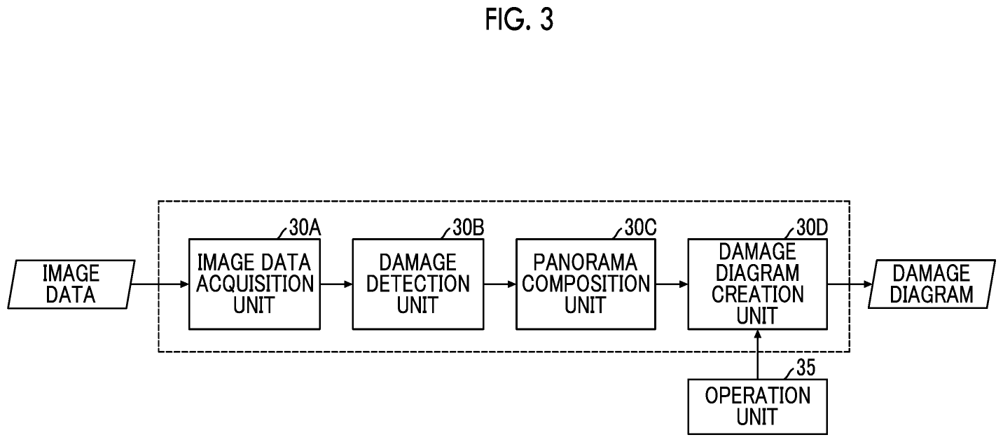

FIG. 3 is a block diagram of the main function of the damage diagram creation support device.

The damage diagram creation support device 30 mainly has functions of an image data acquisition unit 30A, a damage detection unit 30B, a panorama composition unit 30C, and a damage diagram creation unit 30D. These functions are realized by the CPU 31 executing a predetermined program.

The image data acquisition unit 30A acquires image data of the visible light image obtained by imaging the inspection target region. The image data acquisition unit 30A acquires the image data of the visible light image via the input/output interface 37 or the communication interface 38. The image data of the acquired visible light image is stored in the HDD 34.

The damage detection unit 30B analyzes the visible light image and detects damage appearing on the surface of the structure O. In the present embodiment, fissuring is detected as damage. The damage diagram creation support device 30 of the present embodiment has a detection function of detecting damage appearing on the surface of the structure, thereby also functioning as a detection device.

Various methods can be adopted for detecting damage. For example, it is possible to adopt a method of detecting damage using a trained model that has performed machine learning using an image including damage, as training data. The type of machine learning algorithm is not particularly limited, and for example, an algorithm using neural networks, such as a recurrent neural network (RNN), a convolutional neural network (CNN), or a multilayer perceptron (MLP), can be used. Alternatively, for example, a method of detecting damage on the basis of the brightness distribution and the RGB value distribution of the image can also be adopted. Since a region having damage has brightness distribution and RGB value distribution different from other regions, damage can be detected from the image by searching for changes in the brightness value and the RGB value.

A width is also measured in a case where fissuring is detected. A well-known image measurement technique is adopted for the width measurement.

The panorama composition unit 30C generates a single image by performing panorama composition in a case where an image data group of visible light images obtained by split imaging is acquired. The split imaging is a method of dividing the inspection target region into a plurality of regions and imaging each region. The panorama composition unit 30C generates a single image by splicing the images obtained by imaging each region. Since the panorama composition itself is a well-known technique, detailed description thereof will be omitted. The panorama composition unit 30C performs panorama composition processing by performing corrections on each image, such as an enlargement/reduction correction, a tilt correction, and a rotation correction, as necessary. Damage detection can be performed on an image after panorama composition.

The damage diagram creation unit 30D creates a damage diagram. The damage diagram is a diagram in which the occurrence position, range, and condition of damage, the major dimension of representative damage, and the like are described in a drawing (for example, a drawing of industrial data, such as computer-aided design (CAD)). The damage diagram is created manually or automatically in response to an instruction from the user.

In a case where the damage diagram is manually created, for example, a drawing of the inspection target region is displayed on the display unit 36, and the user manually writes the occurrence position, range, and condition of damage, the major dimension of representative damage, and the like on the drawing via the operation unit 35, whereby the damage diagram is created.

In a case where the damage diagram is automatically created, the damage diagram is created using the detection result of the damage detection unit 30B. In the present embodiment, the damage diagram is created by tracing the fissuring detected by the damage detection unit 30B.

In the present embodiment, the damage diagram has a layer structure, and the damage diagram is created by separating the layers for each damage type. Specifically, delamination and fissuring are separately created. Therefore, the delamination layer and the fissuring layer are superimposed, whereby a damage diagram in which both the delamination and the fissuring are represented is generated.

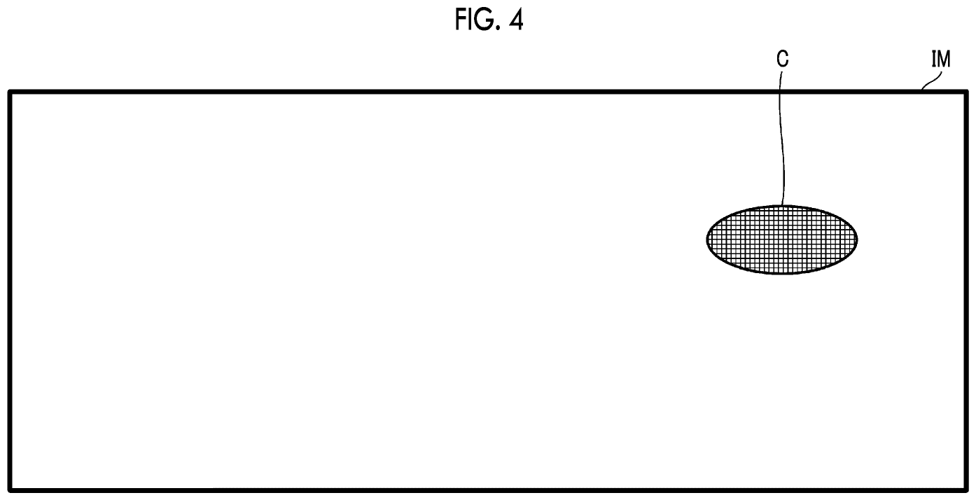

FIG. 4 is a diagram showing an example of a damage diagram in which delamination is recorded.

As shown in FIG. 4, the occurrence location of delamination is surrounded by a circle C in a drawing IM showing the inspection target region, whereby the occurrence position and the range of the delamination can be confirmed on the drawing.

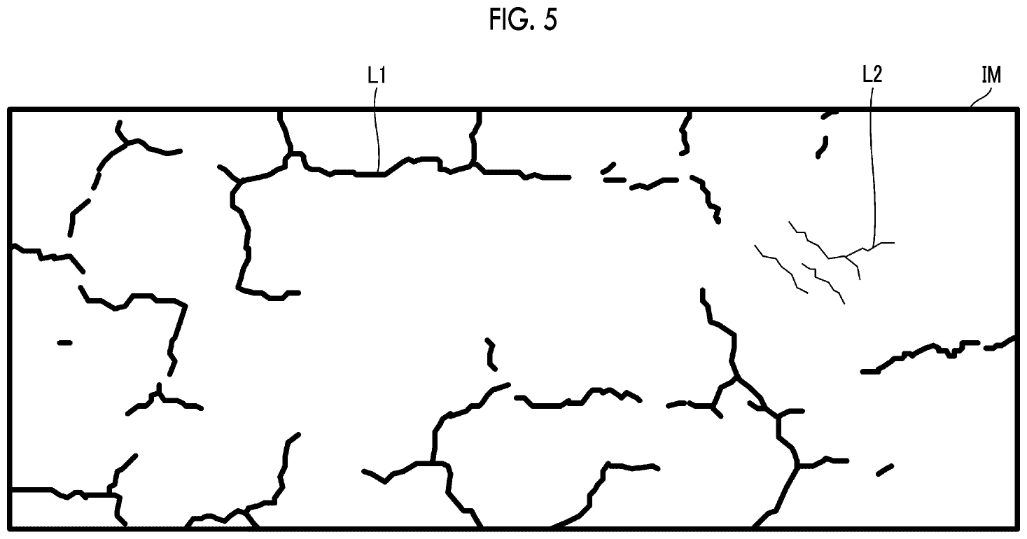

FIG. 5 is a diagram showing an example of a damage diagram in which fissuring is recorded.

As shown in FIG. 5, the fissuring is traced in the drawing IM showing the inspection target region, whereby the occurrence position and the condition of the fissuring can be confirmed on the drawing. In FIG. 5, the fissuring is displayed by changing the thickness of the line to be traced, depending on the width of the fissuring. Specifically, fissuring with a width of 0.2 mm or more is indicated by a thick line L1, and fissuring with a width of 0.1 mm or more and less than 0.2 mm is indicated by a thin line L2.

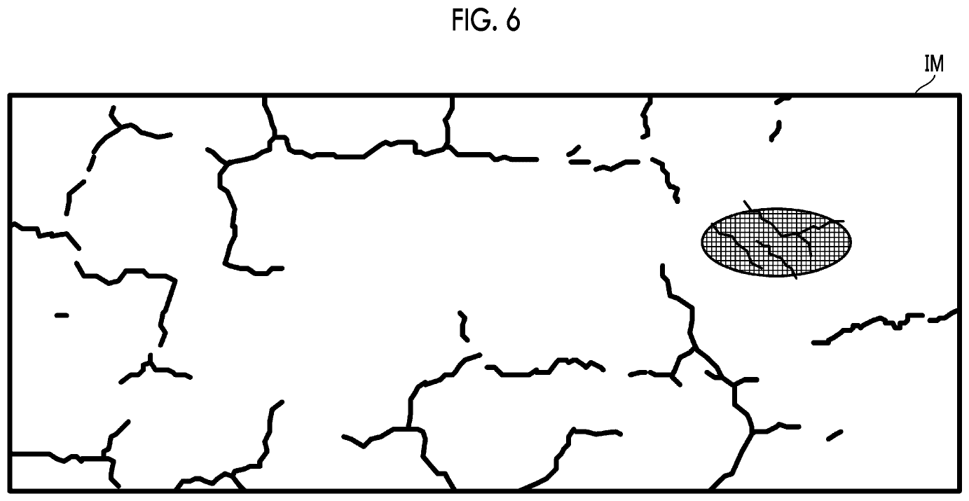

FIG. 6 is a diagram showing an example of a damage diagram in which both delamination and fissuring are recorded.

As shown in FIG. 6, the damage diagram in which both delamination and fissuring are recorded is a superimposition of both damage diagrams. Both the state of the outer surface and the internal state of the structure O can be simultaneously confirmed from the damage diagram in which both the delamination and the fissuring are recorded.

The damage diagram created by the damage diagram creation unit 30D is displayed on the display unit 36. Further, the damage diagram is recorded in the HDD 34 in response to a recording instruction from the user.

[Inspection Method]

Here, a case of inspecting (checking) a bridge, particularly a floor slab of the bridge, will be described as an example. The bridge is an example of the structure. Further, the floor slab is an example of the structure made of reinforced concrete.

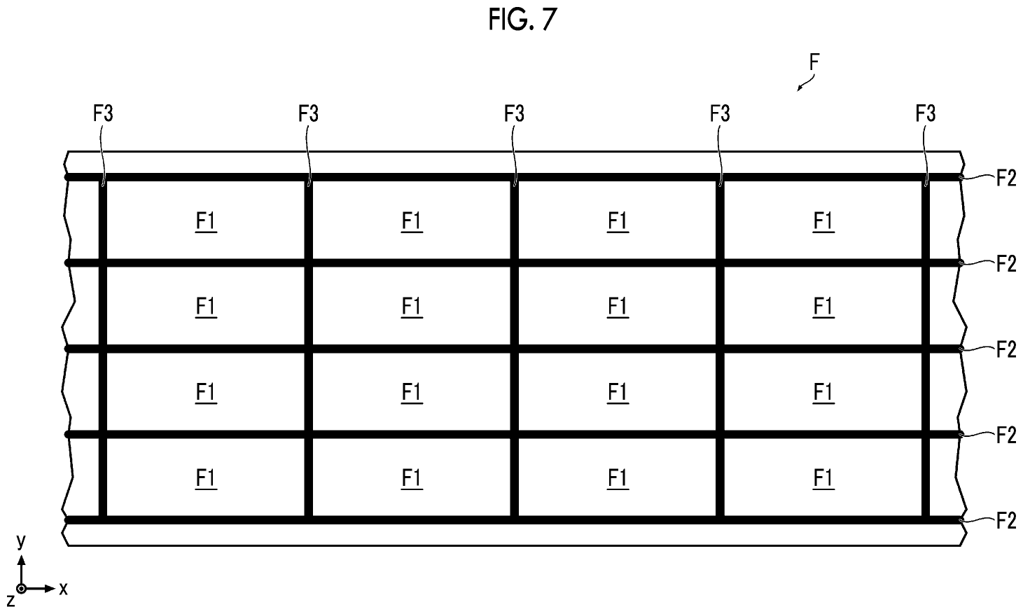

FIG. 7 is a plan view showing a schematic configuration of the floor slab.

In general, a floor slab F is inspected in a coffer unit. A coffer F1 is a compartment of the floor slab F divided by a main girder F2 and a cross-beam F3.

In FIG. 7, in the in-plane of the floor slab F, a longitudinal direction (the direction of the main girder F2) of the floor slab F is set as an x direction, and a direction (the direction of the cross-beam F3) orthogonal to the x direction is set as a y direction. In addition, a direction (vertically downward direction) orthogonal to the floor slab F is set as a z direction.

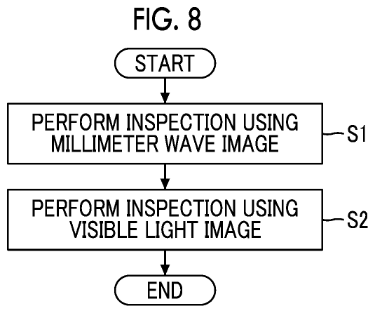

FIG. 8 is a flowchart showing an inspection procedure through a structure inspection method of the present embodiment.

As shown in FIG. 8, in the present embodiment, an inspection using the millimeter wave image is first performed (step S1), and then an inspection using the visible light image is performed (step S2).

The inspection using the millimeter wave image is an inspection in which the inspection target region is imaged using the millimeter wave camera 20 and the internal state of the inspection target region is confirmed in detail on the basis of the obtained millimeter wave image. In the present embodiment, delamination is detected on the basis of the millimeter wave image. The inspection using the millimeter wave image is an example of a step of capturing an image that visualizes the internal state of the inspection target region and non-destructively measuring the internal state of the inspection target region.

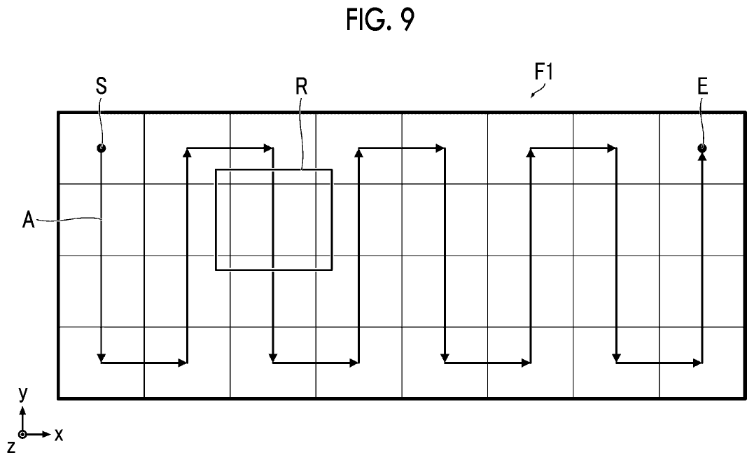

FIG. 9 is a diagram showing an example of capturing the millimeter wave image in one coffer.

As shown in FIG. 9, in the present embodiment, the millimeter wave camera images the coffer F1 a plurality of times while shifting an imaging location.

In the present embodiment, the coffer F1 is divided into a matrix, and each divided region is sequentially imaged by the millimeter wave camera. In FIG. 9, an arrow A indicates the movement direction of imaging. As shown in FIG. 9, the imaging is performed so as to scan the entire coffer F1. FIG. 9 shows an example of a case where imaging is started from a point S and imaging is finished at a point E.

Further, in FIG. 9, a symbol R indicates the imaging range of the millimeter wave camera. As shown in FIG. 9, each region to be divided is set narrower than the imaging range of the millimeter wave camera. With this, the inspection target region can be imaged (inspected) without omission.

The millimeter wave image captured by the millimeter wave camera is an image that visualizes the internal state of the structure. Therefore, the internal state can be confirmed in detail by confirming the captured millimeter wave image. The user confirms the captured millimeter wave image to confirm the presence or absence of delamination. In addition, in a case where delamination is detected, the user confirms details thereof (the occurrence position, range, and condition of the delamination, the major dimension of representative delamination, and the like).

After all inspections of the inspection target region is finished, the user creates a delamination damage diagram on the basis of the inspection result. The damage diagram is created using the damage diagram creation support device 30.

The inspection using the millimeter wave image is performed, whereby the internal state of the inspection target region can be confirmed in detail. With this, in a case where there is internal damage within the inspection target region, information on the location of the damage can be acquired. In the present embodiment, information on the location of the delamination can be acquired.

The inspection using the visible light image is performed after the inspection using the millimeter wave image. In the inspection using the visible light image, the inspection target region is imaged using the visible light camera 10, and damage appearing on the outer surface of the inspection target region is detected on the basis of the obtained visible light image. In the present embodiment, fissuring appearing on the outer surface of the coffer is detected.

Capturing the visible light image is performed in the same method as capturing the millimeter wave image. That is, the visible light camera images the coffer F1 a plurality of times while shifting the imaging location.

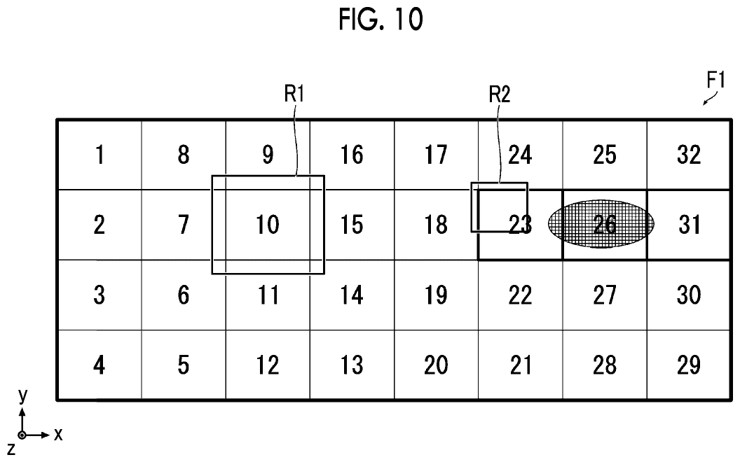

FIG. 10 is a diagram showing an example of capturing the visible light image in one coffer.

As shown in FIG. 10, the coffer F1 is divided into a matrix, and each divided region is sequentially imaged by the visible light camera. In FIG. 10, the numbers (1 to 32) attached to respective regions indicate the order of imaging. As shown in FIG. 10, the imaging is performed so as to scan the entire coffer F1.

In imaging each divided region, the visible light image is captured with a pixel resolution corresponding to the presence or absence of delamination, in the present embodiment. Specifically, a region where no delamination is detected by the inspection using the millimeter wave image is imaged with a relatively low first pixel resolution. On the other hand, a region where delamination is detected by the inspection using the millimeter wave image is imaged with a relatively high second pixel resolution. The region where delamination is detected is a region including a location where the delamination is detected. FIG. 10 shows an example of a case where delamination is detected in regions 23, 26, and 31. In this case, the regions 23, 26, and 31 are imaged with the second pixel resolution, and the other regions are imaged with the first pixel resolution.

Here, the “pixel resolution” refers to the visual field size per pixel of the image sensor mounted on the visible light camera. The pixel resolution indicates how many millimeters one pixel of the image sensor corresponds to. The unit is “mm/pixel”.

The pixel resolution is determined by the visual field size and the number of pixels. The “visual field size” is the range (imaging range) in which the inspection target object is imaged. The relationship between the pixel resolution, the visual field size, and the number of pixels is represented by the following equations.

Pixel resolution in the vertical direction=visual field size (mm) in the vertical direction/the number of pixels in the vertical direction of the image sensor

Pixel resolution in the horizontal direction=visual field size (mm) in the horizontal direction/the number of pixels of the image sensor in the horizontal direction

In a case where the pixels of the image sensor are square pixels, the pixel resolution in the vertical direction and the pixel resolution in the horizontal direction are the same.

For example, in a case where the visual field size in the vertical direction is 30 mm and the number of pixels in the vertical direction of the image sensor is 1200 pixels, the pixel resolution in the vertical direction is a pixel resolution=30 mm/1200 pixels=0.025 [mm/pixel].

In the present embodiment, the first pixel resolution is set to a pixel resolution capable of detecting fissuring with a width of up to 0.2 mm from the captured visible light image. In particular, the pixel resolution is set to a pixel resolution capable of detecting fissuring with a width of up to 0.2 mm through image analysis using a computer. The pixel resolution capable of detecting fissuring with a width of up to 0.2 mm from the captured visible light image is, for example, 0.6 [mm/pixel].

Meanwhile, the second pixel resolution is set to a pixel resolution capable of detecting fissuring with at least a width of up to 0.1 mm from the captured visible light image. In particular, the pixel resolution is set to a pixel resolution capable of detecting fissuring with at least a width of up to 0.1 mm through image analysis using the computer. The pixel resolution capable of detecting fissuring with at least a width of up to 0.1 mm from the captured visible light image is, for example, 0.3 [mm/pixel].

The number of pixels of the image sensor mounted on the visible light camera used is assumed to be, for example, 3000 pixels in the vertical direction and 4000 pixels in the horizontal direction. In this case, in the first pixel resolution, the visual field size in the vertical direction is 0.6 mm×3000 pixels=1800 [mm], and the visual field size in the horizontal direction is 0.6 mm×4000 pixels=2400 [mm]. In the second pixel resolution, the visual field size in the vertical direction is 0.3 mm×3000 pixels=900 [mm], and the visual field size in the horizontal direction is 0.3 mm×4000 pixels=1200 [mm].

In a case where the coffer F1, which is the inspection target region, is divided, the coffer F1 is divided in conformity with the visual field size in a case where imaging is performed with the first pixel resolution. That is, the size of each region is set such that each region can be imaged at one time in a case where imaging is performed with the first pixel resolution. Therefore, the size of each region to be divided is set smaller than the visual field size in a case where imaging is performed with the first pixel resolution. More specifically, the size of each region to be divided is set smaller than the visual field size in a case where imaging is performed with the first pixel resolution, and is set larger than the visual field size in a case where imaging is performed with the second pixel resolution. Further, in a case where each divided region is imaged with the first pixel resolution, the images of the adjacent regions are set so as to partially overlap each other. The images of the adjacent regions are set so as to overlap each other by, for example, 30% or more.

In FIG. 10, a frame R1 indicates the visual field size in a case where imaging is performed with the first pixel resolution. Further, a frame R2 indicates the visual field size in a case where imaging is performed with the second pixel resolution. As shown in FIG. 10, the visual field size in a case where imaging is performed with the first pixel resolution is set larger than the visual field size in a case where imaging is performed with the second pixel resolution.

The pixel resolution can be adjusted by, for example, changing the focal length (zoom) or the imaging distance (working distance).

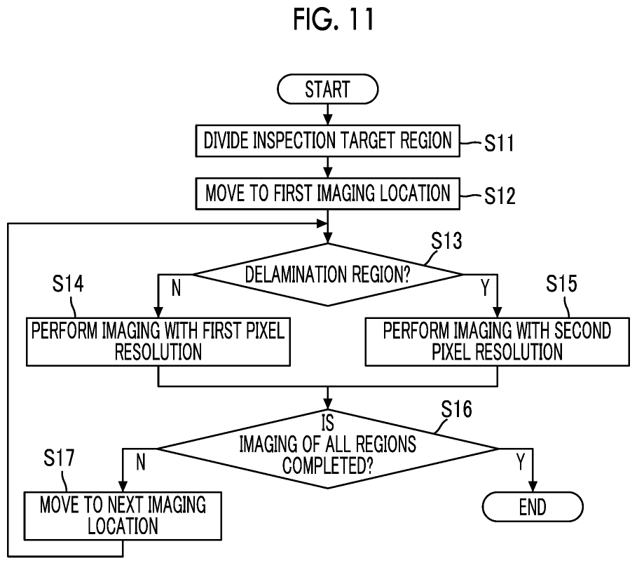

FIG. 11 is a flowchart showing an imaging procedure performed by the visible light camera.

First, the inspection target region is divided (step S11). In the present embodiment, the coffer F1, which is the inspection target region, is divided into a matrix. As described above, the size of each region to be divided is set in conformity with the visual field size in a case where imaging is performed with the first pixel resolution.

After the inspection target region is divided, the imaging location moves to a first imaging location (step S12). That is, the imaging location moves to the imaging location of the region to be imaged first.

Next, whether or not the region to be imaged is a delamination region is determined (step S13). That is, whether or not the region is a region where delamination is detected is determined.

In a case where the region to be imaged is not the delamination region, the region is imaged with the first pixel resolution (step S14). In this case, the imaging of the region is completed at one time.

On the other hand, in a case where the region to be imaged is the delamination region, the region is imaged with the second pixel resolution (step S15). In this case, the region is imaged a plurality of times while shifting the imaging location.

After imaging is finished, whether or not the imaging of all the regions of the inspection target region is completed is determined (step S16). In a case where the imaging of all the regions is completed, the process ends. On the other hand, in a case where the imaging of all the regions is not completed, the imaging location moves to the next imaging location (step S17). Then, returning to step S13, whether or not the region is the delamination region is determined (step S13), and imaging corresponding to the determination result is performed.

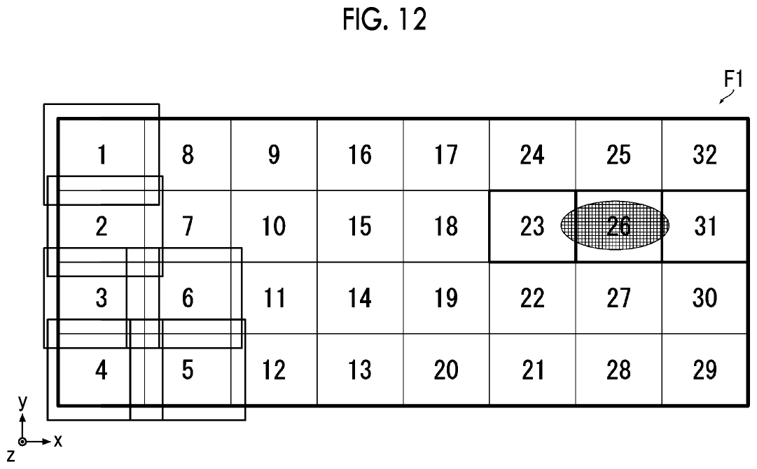

FIG. 12 is a conceptual diagram of visible light image capturing processing in the region where no delamination is detected.

As shown in FIG. 12, each divided region is sequentially imaged with the first pixel resolution. The imaging of each region is completed in one shot.

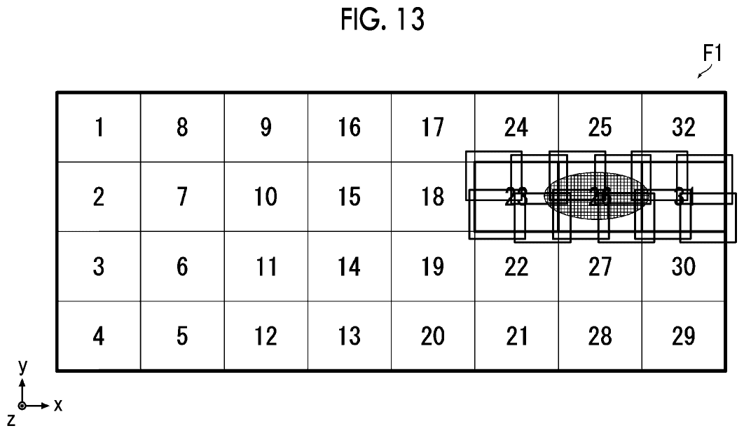

FIG. 13 is a conceptual diagram of visible light image capturing processing in the region where delamination is detected.

In the region where delamination is detected, imaging is performed with the second pixel resolution. The visual field size at the second pixel resolution is smaller than the visual field size at the first pixel resolution. Therefore, as shown in FIG. 13, imaging is performed a plurality of times while shifting the imaging location within the divided regions. Since the second pixel resolution is a pixel resolution higher than the first pixel resolution, more detailed damage can be detected from the captured image.

After all the imaging of the inspection target region is finished, the user creates a damage diagram. The damage diagram is created using the damage diagram creation support device 30. The damage diagram is created by the following procedure. Here, a case where the damage diagram is automatically created from the captured image will be described as an example. First, a captured image group is input to the damage diagram creation support device 30. The damage diagram creation support device 30 analyzes the input image and detects damage appearing on the surface of the structure. In the present embodiment, fissuring is detected as damage. Here, as described above, the image is captured by changing the pixel resolution depending on the presence or absence of delamination. A region without delamination is imaged with the first pixel resolution, and a region with delamination is imaged with the second pixel resolution. The first pixel resolution is a pixel resolution capable of detecting fissuring with a width of up to 0.2 mm from the captured visible light image. Therefore, fissuring with a width of up to 0.2 mm is detected in the region without delamination. Meanwhile, fissuring with at least a width of up to 0.1 mm is detected from the captured visible light image in the second pixel resolution. The damage diagram creation support device 30 performs panorama composition of the input image group to generate a single visible light image in which the inspection target region is imaged. Then, the damage diagram is created by generating an image obtained by tracing the fissuring on the basis of the panorama composite image. In the present embodiment, the damage diagram is created in a layer structure, and a damage diagram for fissuring with a width of 0.2 mm or more and a damage diagram for fissuring with a width of 0.1 mm or more and less than 0.2 mm are separately created. With this, fissuring with a width of 0.2 mm or more and fissuring with a width of 0.1 mm or more and less than 0.2 mm can be separately confirmed as necessary. Both are superimposed, whereby all the fissuring can be confirmed (see FIG. 5).

The created fissuring damage diagram is superimposed and displayed on the delamination damage diagram as necessary. With this, the delamination inside the structure and the fissuring appearing on the outer surface can be confirmed at once (see FIG. 6).

As described above, according to the structure inspection method of the present embodiment, the visible light image is captured with a high pixel resolution only for the region where internal damage is detected in inspecting the outer surface of the structure. With this, the number of total shots in a case where the visible light image is captured can be reduced, and the structure can be efficiently inspected. Meanwhile, since the visible light image is captured with a high pixel resolution for the region where internal damage is detected, damage appearing on the outer surface can be confirmed in detail. With this, deterioration can be predicted with high accuracy.

### Modification Example

In the above embodiment, a configuration is adopted in which the region where internal damage (delamination) is detected is imaged with the second pixel resolution when the visible light image of the inspection target region is captured, and the other region is imaged with the first pixel resolution. A configuration may be adopted in which all the inspection target regions including the region where internal damage is detected are imaged with the first pixel resolution and the region where internal damage is detected is further imaged with the second pixel resolution. In this case as well, since the number of shots imaged with the second pixel resolution can be reduced, the structure can be efficiently inspected.

Further, in the above embodiment, a case where imaging is performed by one visible light camera has been described as an example, but imaging can also be performed using a plurality of the visible light cameras.

### Second Embodiment

In the present embodiment, first, the inspection target region is imaged by the visible light camera, and damage appearing on the surface is detected on the basis of the obtained visible light image. In a case where specific damage is detected on the surface, the internal state of the location where damage is detected is non-destructively measured.

In the present embodiment, fissuring is detected as damage appearing on the surface of the structure. In a case where fissuring with a width of less than 0.2 mm is detected, the internal state of the location where the fissuring with a width of less than 0.2 mm is detected is non-destructively measured. As a non-destructive measurement method, a method of capturing an image that visualizes the internal state is adopted. In particular, in the present embodiment, the internal state is confirmed in detail by capturing the millimeter wave image.

Since a system used for an inspection is the same as the system 1 of the first embodiment, an inspection method will be described here.

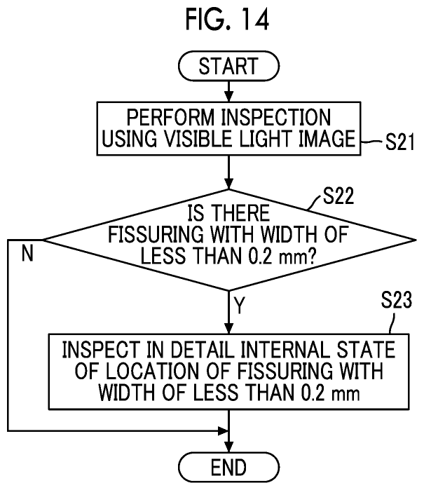

FIG. 14 is a flowchart showing an inspection procedure through a structure inspection method of the present embodiment.

First, the inspection using the visible light image is performed (step S21). The inspection using the visible light image is performed by imaging the inspection target region with the visible light camera and detecting damage (in the present embodiment, fissuring) appearing on the outer surface of the structure from the obtained visible light image.

Imaging is performed with a pixel resolution capable of detecting fissuring with at least a width of up to 0.1 mm from the captured visible light image. In imaging, in a case where the inspection target region cannot be imaged at once, the inspection target region is divided and imaged. That is, the inspection target region is imaged a plurality of times while shifting the imaging location.

The damage diagram is created after the completion of imaging. The damage diagram is created using the damage diagram creation support device 30. The user inputs the captured visible light image to the damage diagram creation support device 30. The damage diagram creation support device 30 automatically generates the damage diagram in response to an instruction from the user. That is, the damage diagram is generated by detecting fissuring from the input visible light image and tracing the detected fissuring. Further, the width of the detected fissuring is measured and the measured width is recorded in the damage diagram. In the damage diagram, it is preferable to change the width or the color of the line to be traced depending on the width of the fissuring. In the present embodiment, furthermore, the damage diagram is created by separating the layers for each width of the fissuring. Specifically, the damage diagram is created in a layer structure in which a layer in which fissuring with a width of 0.2 mm or more is recorded and a layer in which fissuring with a width of less than 0.2 mm is recorded are separated. With this, it is possible to selectively display only fissuring with a width desired by the user.

Whether or not the detailed inspection of the internal state is necessary is determined on the basis of the result of the inspection using the visible light image. Specifically, the presence or absence of the location of fissuring with a width of less than 0.2 mm is determined, and whether or not the detailed inspection of the internal state is necessary is determined (step S22). There is a concern about internal damage (mainly delamination) at the location where fissuring with a width of less than 0.2 mm has occurred. For this reason, the location where fissuring with a width of less than 0.2 mm has occurred is targeted for the detailed inspection.

In a case where fissuring with a width of less than 0.2 mm is detected in the inspection target region, the internal state of the location where fissuring with a width of less than 0.2 mm is detected is non-destructively inspected in detail (step S23).

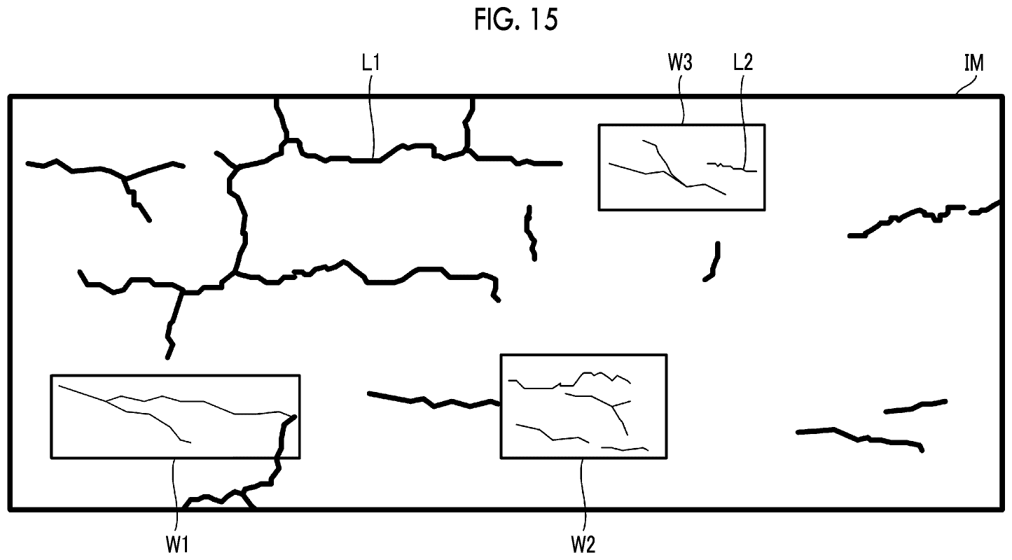

FIG. 15 is a diagram showing an example of a fissuring damage diagram generated by the inspection using the visible light image.

In FIG. 15, fissuring with a width of 0.2 mm or more is indicated by the thick line L1, and fissuring with a width of 0.1 mm or more and less than 0.2 mm is indicated by the thin line L2. In the example shown in FIG. 15, fissuring with a width of less than 0.2 mm is detected at three locations. The location of fissuring with a lump is set as one unit. Therefore, in the example shown in FIG. 15, the detailed inspections of the internal state are performed at three locations. Specifically, the detailed inspections of the internal state are performed at the locations surrounded by rectangular frames W1 to W3.

As described above, the detailed inspection of the internal state is performed by capturing an image that visualizes the internal state. In the present embodiment, the detailed inspection is performed by capturing the millimeter wave image. The user inspects the internal state by imaging the location (the locations surrounded by the frames W1 to W3 in FIG. 15) where fissuring with a width of less than 0.2 mm is detected with the millimeter wave camera 20. The millimeter wave image that visualizes the internal state of the target location is obtained by imaging the target location with the millimeter wave camera 20. The user confirms the millimeter wave image obtained by the imaging to confirm in detail the internal state that cannot be confirmed from the surface. That is, the presence or absence of damage, such as delamination occurring inside, is confirmed.

As described above, in the present embodiment, the internal state is non-destructively inspected in detail only in a case where specific damage (in the present embodiment, fissuring with a width of less than 0.2 mm) is detected as the result of the inspection using the visible light image. With this, a detailed internal inspection is performed only for the location that truly requires the detailed inspection, so that the structure can be efficiently inspected. In addition, the internal state can be inspected in detail for a location suspected of internal damage. With this, deterioration can be predicted with high accuracy.

### Modification Example

[Specific Damage]

In the above embodiment, a configuration is adopted in which the internal state of the location where the fissuring with a width of less than 0.2 mm is detected is inspected in detail in a case where fissuring with a width of less than 0.2 mm is detected as the specific damage. The specific damage type that requires the detailed inspection of the internal state is not limited thereto. It is preferable to inspect the internal state in detail in a case where the type of damage estimated to be internal damage is detected. Examples of the type of damage estimated to be internal damage include water leakage (including rust juice).

[Processing after Detailed Inspection of Internal State]

In the structure made of reinforced concrete, there is a probability of the corrosion of the reinforcing bar being progressing in a case where the internal delamination is large.

In a case where delamination of a predetermined size or more is recognized in inspecting the internal state in detail using the millimeter wave image or the like, it is preferable to further inspect the soundness of the surrounding reinforcing bar thereof. This can be useful for estimating deterioration factors or for supporting subsequent repair design. For example, in a case where delamination of a predetermined depth, for example, delamination of a depth corresponding to the covering thickness of concrete is recognized as a result of visualizing the internal state with the millimeter wave image and the like, the soundness of the reinforcing bar is inspected in detail. A non-destructive inspection method is adopted for inspecting the soundness of the reinforcing bar. The inspection of the soundness is performed by, for example, an electromagnetic induction method, or an electromagnetic wave radar method. The electromagnetic induction method is a method of radiating magnetic lines of force (primary magnetic field) from a magnetic field generation unit of a exploration device toward the concrete, detecting a secondary magnetic field caused by an induced current generated in a conductive substance (reinforcing bar) existing in the concrete through an electromagnetic detection unit, and comparing the increase and decrease of the primary magnetic field and the secondary magnetic field with each other, to detect the reinforcing bar and measure the position thereof. The electromagnetic wave radar method is a method of receiving an electromagnetic wave reflected at the interface with a substance (reinforcing bar) having different electrical properties through a reception unit in a case where the electromagnetic wave is radiated from a transmission unit of a exploration device toward the concrete, to detect the reinforcing bar.

### Other Embodiments

[Unit that Non-Destructively Measures Internal State of Inspection Target Region]

In the above embodiment, a configuration is adopted in which the internal state of the structure is non-destructively measured by capturing the image that visualizes the internal state of the structure with the millimeter wave camera. The unit and method of non-destructively measuring the internal state of the structure are not limited thereto. For example, a configuration can also be adopted in which the internal state of the structure is measured using a device (such as a microwave imaging device and a terahertz imaging device) that visualizes the internal state using an electromagnetic wave, such as a microwave and a terahertz wave (electromagnetic wave radar method). Further, a configuration can also be adopted in which the internal state of the structure is measured using a device (such as an ultrasonic imaging device) that visualizes the internal state using an ultrasonic wave (a so-called ultrasonic method). In addition, a configuration can be adopted in which the internal state of the structure is measured by adopting a well-known non-destructive exploration method, such as an infrared photographic method, an X-ray angiographic method, and a non-contact acoustic exploration method.

[Inspection Target]

The present invention is particularly effective in a case where a structure made of reinforced concrete, such as a bridge, a tunnel, a dam, and a building, is inspected, but the application of the present invention is not limited thereto. In addition, the same can also be applied to, for example, a structure whose surface includes a tile, a brick, or the like.

Further, in the above embodiment, a case where the presence or absence of the delamination of concrete is inspected has been described as an example, but the type of damage as the inspection target is not limited thereto.

[Imaging Method]

Imaging with the visible light camera and the millimeter wave camera can also be performed by mounting the visible light camera and the millimeter wave camera on an unmanned aerial vehicle (a so-called drone), an unmanned traveling vehicle, or the like.

Further, a configuration can also be adopted in which imaging is automatically performed in a case where the visible light camera and the millimeter wave camera are mounted on the unmanned aerial vehicle or the like to image the inspection target. For example, a configuration may be adopted in which the unmanned aerial vehicle automatically flies along a predetermined route and images the inspection target.

[System Configuration]

In the above embodiment, the damage diagram creation support device is realized by a so-called stand-alone computer, but the damage diagram creation support device can also be realized by a client-server system. For example, a configuration may be adopted in which the functions of the damage detection unit 30B, the panorama composition unit 30C, and the damage diagram creation unit 30D may be realized by a server. In this case, the client terminal is provided with a function of transmitting images to the server, a function of receiving results (such as a panorama composite image and damage diagram data) from the server, and the like.

Further, the hardware that realizes the damage diagram creation support device can be composed of various processors. The various processors include, for example, a CPU and/or a graphic processing unit (GPU) which is a general-purpose processor that executes a program to function as various processing units, a programmable logic device (PLD), such as a field programmable gate array (FPGA), which is a processor having a changeable circuit configuration after manufacture, a dedicated electric circuit, such as an application specific integrated circuit (ASIC), which is a processor having a dedicated circuit configuration designed to execute specific processing. One processing unit constituting an inspection support device may be composed of one of the above various processors or two or more of the above various processors of the same type or different types. For example, one processing unit may be composed of a combination of a plurality of FPGAs or a combination of a CPU and an FPGA. Alternatively, a plurality of processing units may be composed of one processor. A first example of the configuration in which a plurality of processing units are composed of one processor includes an aspect in which one or more CPUs and software are combined to constitute one processor, and the processor functions as the plurality of processing units, as represented by a computer, such as a client or a server. A second example is an aspect in which a processor that realizes the functions of the entire system including a plurality of processing units with one integrated circuit (IC) chip is used, as represented by system on chip (SoC) and the like. As described above, various processing units are composed of one or more of the various processors described above as the hardware structure. Further, more specifically, an electric circuit (circuitry) in which circuit elements, such as semiconductor elements, are combined is used as the hardware structure of these various processors.

### EXPLANATION OF REFERENCES

1: system used for an inspection
10: visible light camera
20: millimeter wave camera
23: region
26: region
30: damage diagram creation support device
30A: image data acquisition unit
30B: damage detection unit
30C: panorama composition unit
30D: damage diagram creation unit
31: CPU
32: RAM
33: ROM
34: HDD
35: operation unit
36: display unit
37: input/output interface
38: communication interface
A: imaging movement method
C: occurrence location of delamination
F: floor slab
F1: coffer
F2: main girder
F3: cross-beam
IM: drawing showing an inspection target region
L1: fissuring with a width of 0.2 mm or more
L2: fissuring with a width of less than 0.2 mm
O: structure
R1: visual field size in a case where imaging is performed with a first pixel resolution
R2: visual field size in a case where imaging is performed with a second pixel resolution
S1 and S2: structure inspection procedure
S11 to S17: imaging procedure performed by the visible light camera
S21 to S23: structure inspection procedure
W1 to W3: location where fissuring with a width of less than 0.2 mm is detected

What is claimed is:

1. A structure inspection method comprising:
acquiring information on a location having internal damage to a structure within an inspection target region; and
imaging the inspection target region with a visible light camera a plurality of times while shifting an imaging location, in which a location except for the location having the internal damage is imaged with a first pixel resolution and the location having the internal damage is imaged with a second pixel resolution higher than the first pixel resolution.

2. The structure inspection method according to claim 1, further comprising:
non-destructively measuring an internal state of the inspection target region.

3. The structure inspection method according to claim 2,
wherein the internal state of the inspection target region is non-destructively measured by capturing an image that visualizes the internal state of the inspection target region.

4. The structure inspection method according to claim 3,
wherein the image that visualizes the internal state of the inspection target region is captured using an electromagnetic wave or an ultrasonic wave.

5. The structure inspection method according to claim 4,
wherein the image that visualizes the internal state of the inspection target region is captured using a millimeter wave, a microwave, or a terahertz wave.

6. The structure inspection method according to claim 3,
wherein the inspection target region is imaged a plurality of times while shifting the imaging location in a case where the image that visualizes the internal state of the inspection target region is captured.

7. The structure inspection method according to claim 2,
wherein the internal state of the inspection target region is measured by a non-contact acoustic exploration method.

8. The structure inspection method according to claim 1, further comprising:
detecting damage appearing on a surface of the structure on the basis of a visible light image captured by the visible light camera.

9. The structure inspection method according to claim 1,
wherein a location where delamination has occurred is detected as the location having the internal damage to the structure.

10. The structure inspection method according to claim 1,
wherein the first pixel resolution is a pixel resolution capable of detecting fissuring with a width of up to 0.2 mm from a visible light image captured by the visible light camera, and
the second pixel resolution is a pixel resolution capable of detecting fissuring with at least a width of up to 0.1 mm from the visible light image captured by the visible light camera.

11. A structure inspection method comprising:
imaging an inspection target region of a structure with a visible light camera;
detecting damage appearing on a surface of the structure on the basis of a visible light image captured by the visible light camera; and
non-destructively measuring an internal state of a location where specific damage is detected, in a case where the specific damage is detected.

12. The structure inspection method according to claim 11,
wherein in the imaging of the inspection target region with the visible light camera, imaging is performed with a pixel resolution capable of detecting fissuring with at least a width of up to 0.1 mm from the captured visible light image, and
in the non-destructively measuring of the internal state of the location where the specific damage is detected, an internal state of a location where fissuring with a width of less than 0.2 mm is detected is non-destructively measured.

13. The structure inspection method according to claim 11,
wherein the internal state of the location where the specific damage is detected is non-destructively measured by capturing an image that visualizes the internal state of the location where the specific damage is detected.

14. The structure inspection method according to claim 13,
wherein the image that visualizes the internal state of the location where the specific damage is detected is captured using an electromagnetic wave or an ultrasonic wave.

15. The structure inspection method according to claim 14,
wherein the image that visualizes the internal state of the location where the specific damage is detected is captured using a millimeter wave, a microwave, or a terahertz wave.

16. The structure inspection method according to claim 11
wherein the internal state of the location where the specific damage is detected is measured by a non-contact acoustic exploration method.

17. The structure inspection method according to claim 11,
wherein in the imaging of the inspection target region with the visible light camera, the inspection target region is imaged with the visible light camera a plurality of times while shifting an imaging location.

18. A structure inspection system comprising:
a first camera that captures an image which visualizes an internal state of a structure;
a second camera that captures a visible light image of a surface of the structure; and
a detector that acquires the visible light image captured by the second camera and detects damage appearing on the surface of the structure,
wherein in a case where the visible light image of a surface of an inspection target region of the structure is captured by the second camera, information on a location having internal damage is acquired by capturing an image that visualizes an internal state of the inspection target region of the structure with the first camera in advance, and a location except for the location having the internal damage is imaged with a first pixel resolution, and the location having the internal damage is imaged with a second pixel resolution higher than the first pixel resolution.
